(19) United States
(12) Patent Application Publication
(10) Pub. No.: US 2026/0145719 A1
(43) Pub. Date: May 28, 2026

(54) FLATBED TROLLEY CONSISTING OF FOLDABLE BED AND CASTERS

(71) Applicant: FIND PRODUCTS INC., Yongin-si (KR)

(72) Inventors: Jae Ho SONG, Yongin-si (KR); Won Seok SONG, Yongin-si (KR); Bo Kyung SONG, Suwon-si (KR)

(21) Appl. No.: 19/324,556

(22) Filed: Sep. 10, 2025

(30) Foreign Application Priority Data
Nov. 26, 2024 (KR) 10-2024-0171011

(51) Int. Cl. B62B 3/02; B62B 5/06

(52) U.S. Cl. CPC B62B 3/02; B62B 5/067; B62B 2205/12

(57) ABSTRACT

A flatbed trolley includes a bed rotating shaft, and a bed unit placed parallel to the ground. The bed unit is connected to the bed rotating shaft via a bed hinge unit. As a trolley handle unit is folded to a side of the bed unit and the bed unit rotates about the bed rotating shaft to be folded, bed caster units are also rotated and folded in an inner space on a lower part of the bed. When the bed unit is completely folded, bed caster units are completely stored in the inner space on the lower part of the bed to be automatically folded and concealed between bed parts. Thus, the bed is folded in half, casters are automatically concealed between the two folded halves of the bed, and a handle is also folded together with the bed while being embedded in the bed.

### CROSS-REFERENCE TO RELATED APPLICATIONS

Not applicable.

### FIELD OF THE INVENTION

The present disclosure relates to a flatbed trolley and, more particularly, to a trolley in which a bed of the trolley is folded in half, transport casters are also folded and stored within the bed, and a handle is also folded together with the bed, thereby maximizing hygiene, aesthetics, and convenience in storage and portability.

### BACKGROUND OF THE INVENTION

Generally, a trolley is a transport device that allows items to be loaded and easily moved using casters located at a bottom.

Such a trolley includes as a bed that is configured horizontally with respect to the ground to allow items to be loaded thereon, a caster unit that protrudes vertically from the underside of the bed to facilitate movement of the items loaded on the bed, and a handle unit that is connected to one end of the bed to allow the bed to be easily pulled using the caster unit.

Meanwhile, when transporting an item larger than the bed, the trolley may be configured without the handle unit to avoid interference.

Although the trolley configured in this way is very useful for transporting items, the bed, casters, and handle have considerable volume, which causes significant inconvenience in storage and portability when the trolley is not in use.

In addition, since the casters are usually contaminated during the process of transporting items, there is a problem in that it is difficult to store and carry for aesthetic or sanitary reasons.

Among conventional trolleys, there is a prior art in which the handle connected to the bed is folded to reduce space during storage. However, since the casters provided beneath the bed are not folded, there is a limit to reducing the volume. In addition, there is a problem in that the contaminated casters are exposed, making storage and portability inconvenient.

Further, there is a prior art in which the handle and caster connected to the bed are configured to be simply folded. However, even if the handle and the caster are folded, the area of the bed may not be reduced. Even if the caster is folded, it remains exposed on one side of the bed, resulting in a problem that the contaminated caster is not completely covered.

Further, folding or unfolding the handle and caster connected to the bed requires multiple inconvenient steps, leading to reduced user convenience.

Patent documents related to the present disclosure include U.S. Patent “Flat Platform Cart with Foldable Casters” (Patent Document 1) and U.S. Patent “Flatbed Trolley with Non-Folding Casters When Handle Rotates” (Patent Document 2), both of which disclose prior art in which the handle unit connected to the bed folds, and the casters fold underneath.

Further, U.S. Patent Publication “Flatbed Truck with Foldable Caster Unit” (Patent Document 3) discloses prior art in which the handle unit connected to the bed folds, and the casters fold underneath via a rotating unit.

In addition, U.S. Patent Publication “Platform Cart” (Patent Document 4) discloses prior art in which the handle unit connected to the bed folds, and the casters are detached and stored beneath the bed.

Further, Korean Patent Publication “Portable Foldable Cart” (Patent Document 5) discloses prior art in which the bed may be folded for storage, and the handle is configured according to the folding sections of the bed.

### PRIOR ART DOCUMENT

(Patent Document 1) U.S. Pat. No. 7,784,816 (Aug. 31, 2010)
(Patent Document 2) U.S. Pat. No. 10,086,860 (Oct. 2, 2018)
(Patent Document 3) U.S. Patent Publication No. US2023/0066055 (Mar. 2, 2023)
(Patent Document 4) U.S. Patent Publication No. US2024/0253678 (Aug. 1, 2024)
(Patent Document 5) Korean Patent Publication No. 10-2012-0000001 (Jan. 3, 2012)

### SUMMARY OF THE INVENTION

The present disclosure has been devised to solve the above problems, and an objective of the present disclosure is to provide a trolley which remains faithful to an original function of a trolley as a convenient tool for transporting items, and in which a handle, casters, and a bed are folded in half when not in use, thereby providing improved space efficiency during storage and enhancing convenience when carrying.

Further, an objective of the present disclosure is to provide a trolley that is configured so that contaminated casters are completely covered so as not to be exposed when the trolley is folded for storage, thereby providing aesthetic and hygienic advantages.

Furthermore, an objective of the present disclosure is to provide a trolley that is configured to be used very intuitively and conveniently during the process of folding or unfolding the trolley, thereby maximizing user convenience.

According to an embodiment of the present disclosure, a flatbed trolley includes a bed rotating shaft along which a bed unit is folded, and the bed unit placed parallel to the ground so that an item is loaded thereon.

The bed unit may be connected to the bed rotating shaft via a bed hinge unit.

The bed unit may be configured to include a bed, and the bed may include a front bed part and a rear bed part.

The bed hinge unit may include a front-bed-part hinge and a rear-bed-part hinge.

The front bed part may be connected to one side of the bed rotating shaft via the front-bed-part hinge and be configured to rotate downward about the bed rotating shaft.

Further, the rear bed part may be connected to the other side of the bed rotating shaft via the rear-bed-part hinge and be configured to rotate downward about the bed rotating shaft.

The front bed part may include on a lower portion thereof one or more front-bed-part caster units.

The front-bed-part caster unit may include a front bed part caster and a front bed part caster hinge.

The front-bed-part caster unit may be connected to the front bed part and the front bed part caster hinge, and be configured such that the front bed part caster protruding vertically from a lower surface of the front bed part is foldable while rotating toward the lower surface of the front bed part.

The rear bed part may include on a lower portion thereof one or more rear-bed-part caster units.

The rear-bed-part caster unit may include a rear bed part caster and a rear bed part caster hinge.

The rear-bed-part caster unit may be connected to the rear bed part and the rear bed part caster hinge, and be configured such that the rear bed part caster protruding vertically from a lower surface of the rear bed part is foldable while rotating toward the lower surface of the rear bed part.

When the bed unit is unfolded horizontally, the front bed part caster and the rear bed part caster may protrude vertically from the lower surfaces of the front bed part and the rear bed part, respectively, to allow articles to be loaded and transported.

The front bed part and the rear bed part of the bed unit may be configured to be rotated and folded about the bed rotating shaft so that they come into contact with each other on an inner lower side.

When the front bed part and the rear bed part of the bed unit are folded to contact each other, the front-bed-part caster unit and the rear-bed-part caster unit may b rotated and folded beneath the front bed part and the rear bed part, respectively, so that the bed unit may be folded in half and simultaneously the front bed part caster and the rear bed part caster may also automatically be folded and concealed between the folded front bed part and rear bed part.

Each of the front-bed-part caster unit and rear-bed-part caster unit may include a caster rod that rotates in a direction perpendicular to a rotating direction of the bed hinge unit.

Each caster rod may be connected to the bed rotating shaft.

When each of the front bed part and the rear bed part rotates downward about the bed rotating shaft to be folded, each of the bed casters may rotate to the lower surface of each of the front bed part and the rear bed part to be folded as each caster rod rotates. When each of the front bed part and the rear bed part rotates in an opposite direction about the bed rotating shaft to be unfolded, each of the bed casters may rotate in a direction perpendicular to each of the front bed part and the rear bed part to be unfolded as each caster rod rotates in an opposite direction.

The caster rod may include a caster rod vertical protrusion that protrudes perpendicularly from one side thereof and rotates the caster rod as the bed hinge of each of the front bed part and the rear bed part rotates.

Further, the caster rod vertical protrusion may be connected to the bed rotating shaft. At this time, a caster-rod vertical-protrusion guide groove may be provided at a position where the bed rotating shaft meets the caster rod vertical protrusion to guide rotation of the caster rod vertical protrusion that is inserted to rotate the caster rod as each bed hinge rotates.

As the front bed part and the rear bed part rotate about the bed rotating shaft, the caster rod vertical protrusion inserted into the caster-rod vertical-protrusion guide groove may be guided along a shape of the caster-rod vertical-protrusion guide groove to be rotated, thereby rotating the caster rod.

According to another embodiment of the present disclosure, the flatbed trolley is configured such that one side of each caster rod and the bed rotating shaft are connected to engage with each other via bevel gears, and the caster rod is rotated as the front bed part and the rear bed part rotate about the bed rotating shaft by rotation of the bevel gears.

The bed hinge unit connected to the bed rotating shaft may include a bed hinge locking bar that locks the bed hinge unit to prevent the bed unit from being folded when the bed unit is unfolded and used, and unlocks the bed hinge unit only when necessary to allow the bed unit to be folded.

The flatbed trolley may include a rotary lifting handle on a predetermined portion where the bed rotating shaft and the bed hinge unit meet each other, so as to lift the flatbed trolley when the bed unit is folded.

One side of the rotary lifting handle may be connected to one end of the bed rotating shaft or the bed hinge unit via a rotary lifting handle hinge, and the rotary lifting handle may include on the other side thereof a bed hinge locking bar release protrusion.

As the bed hinge locking bar release protrusion rotates about the rotary lifting handle hinge when the rotary lifting handle is lifted, the bed hinge locking bar release protrusion presses one end of the bed hinge locking bar, so that the bed hinge locking bar is removed from the bed hinge unit, thereby unlocking the bed hinge unit and allowing it to rotate, whereby the front bed part and the rear bed part automatically rotate and fold about the bed rotating shaft.

According to a further embodiment of the present disclosure, the flatbed trolley may include a fixed lifting handle hole in a predetermined portion where the bed rotating shaft and the bed hinge unit meet each other, so as to hold and lift the bed rotating shaft of the flatbed trolley by hand.

A portion of the bed rotating shaft exposed through the fixed lifting handle hole may be configured to serve as the fixed lifting handle, and the fixed lifting handle may be provided with a bed hinge release button to release the bed hinge locking bar.

When the bed unit is folded, pressing the bed hinge release button causes the bed hinge locking bar connected thereto to be disengaged from the bed hinge unit, thereby unlocking the bed hinge unit and allowing it to rotate, whereby the front bed part and the rear bed part may rotate about the bed rotating shaft to be folded.

A trolley handle unit for pushing or pulling the flatbed trolley may be included on one side of the bed unit.

The trolley handle unit may include a trolley handle that is directly held by hand to push or pull the trolley, and a trolley-handle support bar that connects the trolley handle to one side of the bed unit and supports it.

The trolley-handle support bar may be connected to the bed unit via the trolley-handle lower hinge, allowing the trolley handle unit to be folded down toward an upper surface of the bed unit, a trolley-handle fixing projection may be provided on a lower end of the trolley-handle support bar, a trolley-handle fixing-projection insertion groove may be provided on one end of the bed unit that meets the fixing projection, so that when the trolley handle unit is in an upright position, the trolley-handle fixing projection may be inserted into the trolley-handle fixing-projection insertion groove, thereby supporting the trolley handle unit to prevent it from being unintentionally folded.

The trolley handle unit may be provided with a trolley-handle bending hinge to be folded together with the trolley-handle support bar, when the bed unit rotates about the bed rotating shaft to be folded.

The trolley-handle bending hinge may be composed of an upper trolley-handle bending hinge and a lower trolley-handle bending hinge, which are connected to each other by a hinge, allowing them to rotate relative to each other and fold.

The upper trolley-handle bending hinge or the lower trolley-handle bending hinge may include on one side thereof a trolley-handle bending hinge fixing plate, and the upper trolley-handle bending hinge or the lower trolley-handle bending hinge may include on the other side thereof a trolley-handle bending hinge fixing-plate insertion groove, so that when the trolley-handle bending hinge fixing plate is inserted into the trolley-handle bending hinge fixing-plate insertion groove, the trolley handle unit may be supported in an unfolded state without being folded around the trolley-handle bending hinge, and when the trolley-handle bending hinge fixing plate may be disengaged and released from the trolley-handle bending hinge fixing-plate insertion groove, the trolley handle unit becomes in a state where it is rotatable and foldable around the trolley-handle bending hinge, so that when the bed unit is folded by rotating about the bed rotating shaft, the trolley handle unit may also be folded by rotating about the trolley-handle bending hinge.

The trolley handle unit may include a trolley-handle fixing part connecting rod that connects the trolley-handle fixing projection and the trolley-handle bending hinge fixing plate to each other so that the trolley-handle fixing projection and the trolley-handle bending hinge fixing plate are integrally moved.

Further, the trolley handle unit may include a trolley-handle release button to perform a release operation by pressing or pulling the trolley-handle fixing projection and the trolley-handle bending hinge fixing plate connected to each other, a trolley-handle release button connecting rod may be provided to connect the trolley-handle release button with the trolley-handle fixing projection and the trolley-handle bending hinge fixing plate, which are interconnected to each other, and through a single operation of pressing or pulling the trolley-handle release button, the trolley-handle fixing projection and the trolley-handle bending hinge fixing plate, which are connected to each other, may be released simultaneously.

A trolley-handle fixing projection guide may be provided on one side of the bed unit that meets the trolley-handle fixing projection, and when the trolley handle unit is laid down toward the upper surface of the bed unit, the trolley-handle fixing projection guide may pull the trolley-handle fixing projection, and at this time, the trolley-handle bending hinge fixing plate connected to the trolley-handle fixing part connecting rod may also automatically be pulled to be released, so that when the bed unit is unfolded and the trolley handle unit is laid down toward the upper surface of the bed unit, the trolley handle unit may be folded in half or unfolded, and the laid-down trolley handle unit may be raised without requiring any additional unlocking operation, such as pressing or pulling the trolley-handle release button.

### Advantageous Effects

The present disclosure is advantageous in that, when folding a flatbed trolley, a bed occupying the largest area is folded in half, casters are automatically embedded and concealed between two folded halves of the bed, and a handle is likewise folded in half together with the bed while being embedded within the bed, thereby allowing for highly compact storage and portability.

Further, the present disclosure is advantageous in that when only a handle is folded down toward an upper surface of a bed while the bed of the trolley is unfolded, the handle is embedded within the bed, transforming the trolley into a handle-less form, thereby allowing easy use even when loading and transporting bulky items.

Further, when a flatbed trolley is in a folded state, a contaminated caster is completely concealed, which is advantageous in terms of aesthetics and hygiene. This allows a user to carry or transport the trolley without hesitation.

Further, when folding a flatbed trolley, simply lowering a trolley handle toward an upper surface of a bed and then lifting the trolley using a lifting handle allows the bed, caster, and handle to be folded all at once, thereby making it very convenient to use.

Conversely, when one desires to unfold a flatbed trolley, simply unfolding both ends of the folded bed causes the bed and caster to be simultaneously unfolded. Likewise, simply lifting the trolley handle causes it to automatically stand and remain supported in an upright position, thereby allowing a user to very intuitively and conveniently use.

### BRIEF DESCRIPTION OF DRAWINGS

FIG. 1 is a perspective view illustrating a flatbed trolley according to an embodiment of the present disclosure.

FIG. 2 is a perspective view of the flatbed trolley according to an embodiment of the present disclosure when seen from below and an enlarged view showing the configuration of a bed rotating shaft and a bed hinge unit.

FIG. 3 is an exploded perspective view illustrating the flatbed trolley according to an embodiment of the present disclosure.

FIG. 4 is a perspective view illustrating an intermediate process in which a trolley handle unit of the flatbed trolley according to an embodiment of the present disclosure is folded.

FIG. 5 is a perspective view illustrating a state in which a trolley handle unit of the flatbed trolley according to an embodiment of the present disclosure is folded and embedded in an upper surface of a bed unit.

FIG. 6 is a perspective view illustrating an intermediate process in which the bed unit and bed casters are folded to fold the flatbed trolley according to an embodiment of the present disclosure.

FIG. 7 is a perspective view illustrating a state in which the bed unit and the trolley handle unit are completely folded in half and the bed casters are also completely rotated and folded between two beds, according to an embodiment of the present disclosure.

FIGS. 8 and 9 are a perspective view and a partially enlarged perspective view illustrating the operational state of a caster rod vertical protrusion and a caster-rod vertical-protrusion guide groove when the bed unit of the flatbed trolley according to an embodiment of the present disclosure is unfolded and folded.

FIG. 10 is a sectional view showing a configuration taken along line A-A of FIG. 5.

FIG. 11 is a sectional view showing a configuration taken along line b-b of FIG. 10.

FIG. 12 is a sectional view taken along line A-A of FIG. 5 in a state where a lifting handle of the flatbed trolley according to an embodiment of the present disclosure is lifted.

FIG. 13 is a sectional view showing a configuration taken along line b-b of FIG. 12.

FIG. 14 is a perspective view illustrating a flatbed trolley to which a fixed lifting handle is applied, according to another embodiment of the present disclosure.

FIG. 15 is a sectional view showing a configuration taken along line C-C of FIG. 14.

FIG. 16 is a sectional view showing a configuration taken along line d-d of FIG. 15.

FIG. 17 is a sectional view taken along line C-C of FIG. 14 in a state where a bed locking button of a flatbed trolley according to another embodiment of the present disclosure is pressed.

FIG. 18 is a sectional view showing a configuration taken along line d-d of FIG. 17.

FIG. 19 is a sectional view and a partially enlarged sectional view showing a state in which a trolley handle unit of a flatbed trolley according to an embodiment of the present disclosure is supported when erected.

FIG. 20 is a sectional view and a partially enlarged sectional view showing an intermediate process in which the trolley handle unit of the flatbed trolley according to an embodiment of the present disclosure is folded onto the upper surface of the bed unit.

FIG. 21 is a sectional view and a partially enlarged sectional view showing a state in which the trolley handle unit of the flatbed trolley according to an embodiment of the present disclosure is folded and embedded in a trolley-handle storage groove on the upper surface of the bed unit and then is foldable together with the bed unit.

FIG. 22 is perspective view showing a configuration in which a trolley-handle fixing part connecting rod and a trolley-handle release button connecting rod are connected to each other.

FIG. 23 is a diagram showing the prior art in which a cart handle is folded over a bed.

FIG. 24 is a diagram showing the prior art in which a cart caster is folded at a lower portion of the bed.

### DETAILED DESCRIPTION OF THE INVENTION

A flatbed trolley according to an embodiment of the present disclosure will be described below in detail with reference to the accompanying drawings. Hereinafter, descriptions of well-known prior art will be omitted or briefly provided in order to clearly illustrate the gist of the present disclosure.

Respective components included in the description of the present disclosure operate individually or in combination.

In addition, it is to be noted that terms used to refer to components in the present disclosure are defined and used to appropriately describe their respective functions.

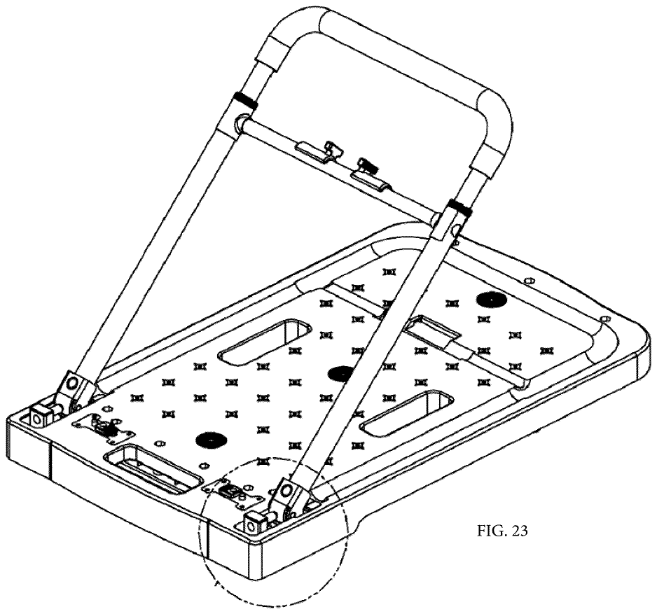

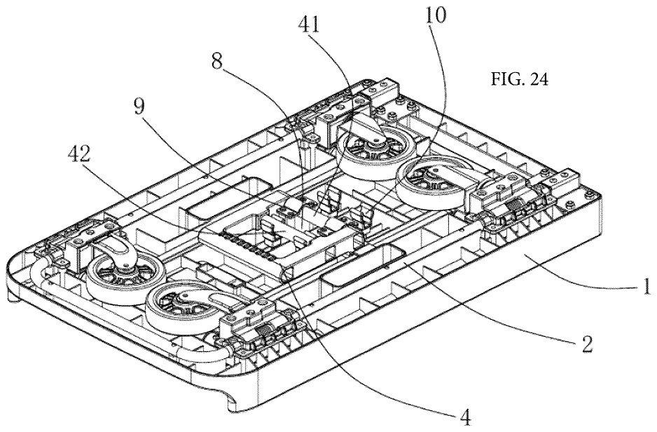

FIG. 23 is a diagram showing the prior art in which a cart handle is folded over a bed, and FIG. 24 is a diagram showing the prior art in which a cart caster is folded at a lower portion of the bed.

According to conventional technologies for folding and storing the cart, in order to store the cart that has been used, a groove is formed in the bed and a handle coupled to the bed is simply put and stored in the groove of the bed as shown in FIG. 23, or a lower caster is simply folded for storage as shown in FIG. 24.

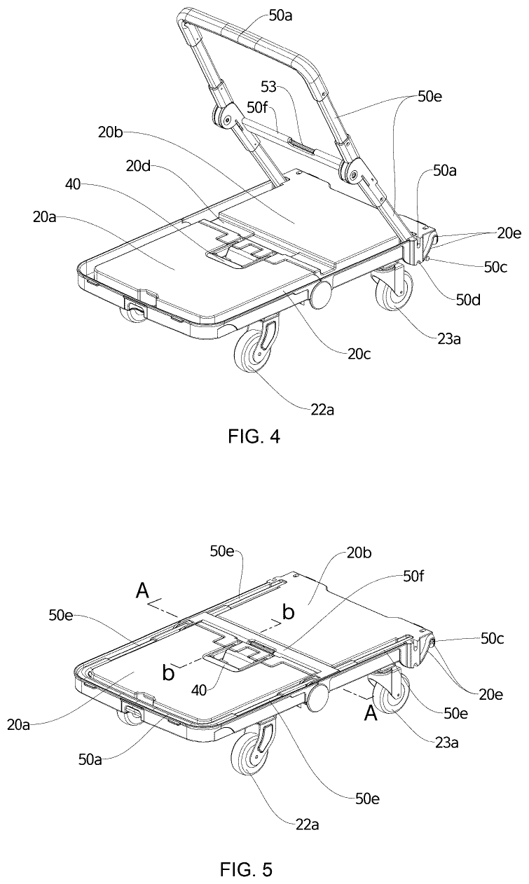

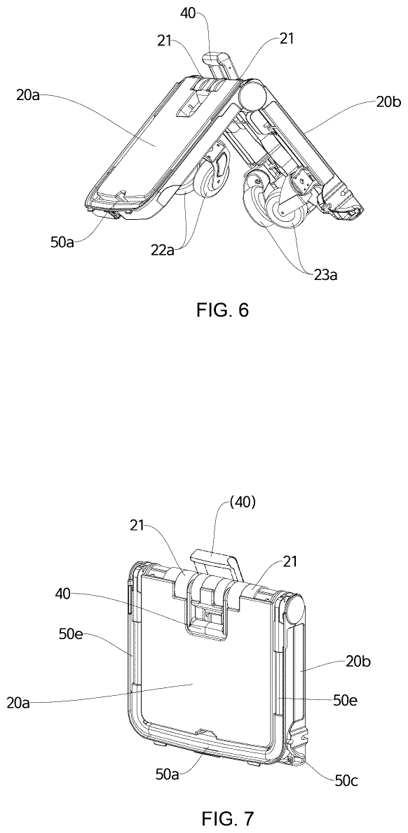

The present disclosure is improved to solve the problems of the prior art. As shown in FIG. 4, a trolley handle unit 50 is folded to a side of a bed unit 20 to fold and store or carry the flatbed trolley 100 for transport. As shown in FIG. 5, the trolley handle unit 50 is embedded in a trolley-handle storage groove 20c formed in an upper portion of the bed unit 20. Then, as shown in FIG. 6, as the bed unit 20 in which the trolley handle unit 50 is embedded rotates about a bed rotating shaft 10 to be folded, bed caster units 22 and 23 also rotate and fold into an inner space underneath the bed. As shown in FIG. 7, when the bed unit 20 is completely folded, the bed caster units 22 and 23 are completely received in the inner space underneath the bed and are automatically folded and concealed between beds 20a and 20b.

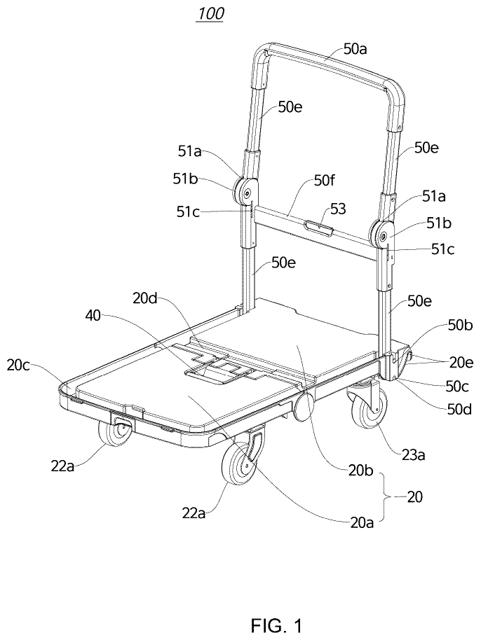

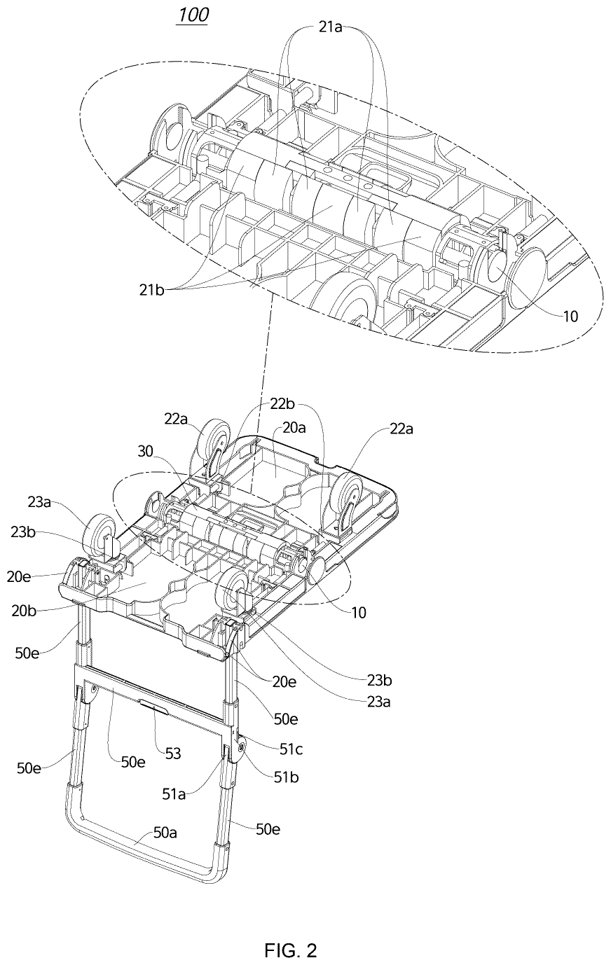

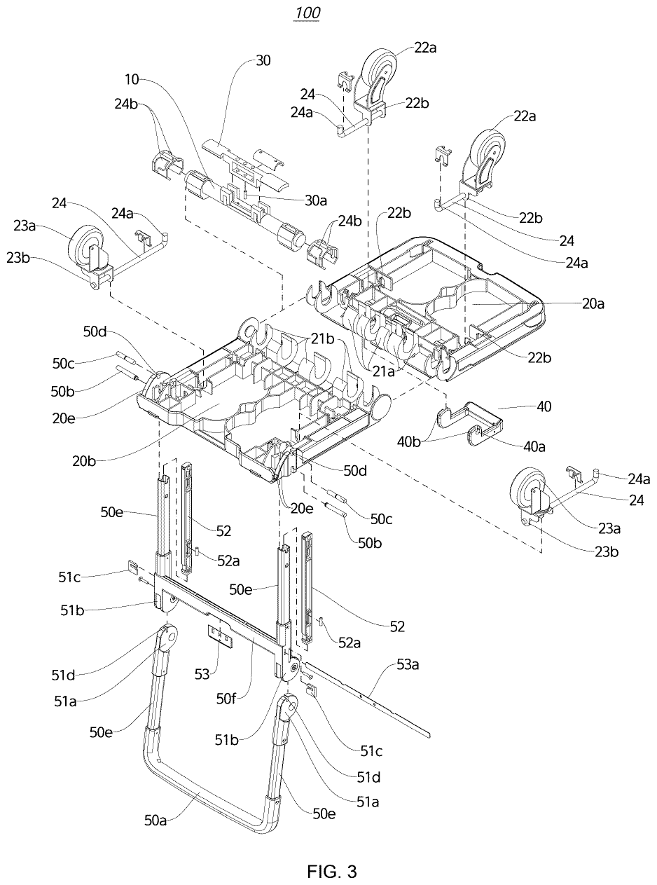

FIG. 1 is a perspective view illustrating a flatbed trolley according to an embodiment of the present disclosure, FIG. 2 is a perspective view of the flatbed trolley according to an embodiment of the present disclosure when seen from below and an enlarged view showing the configuration of the bed rotating shaft and a bed hinge unit, and FIG. 3 is an exploded perspective view illustrating each component included in the flatbed trolley according to an embodiment of the present disclosure.

As shown in FIGS. 1 to 3, the flatbed trolley 100 according to an embodiment of the present disclosure includes the bed rotating shaft 10 along which the bed unit 20 is folded, and the bed unit 20 which is placed parallel to the ground and on which items are loaded.

Hereinafter, the configuration of the bed unit 20 will be described in detail.

The bed unit 20 is connected to the bed rotating shaft 10 via a bed hinge unit 21.

The bed unit 20 is a configuration including the bed, and the bed includes a front bed part 20a and a rear bed part 20b.

The bed hinge unit 21 includes a front-bed-part hinge 21a and a rear-bed-part hinge 21b.

As shown in FIGS. 2 and 3, the front bed part 20a is connected to one side of the bed rotating shaft 10 via the front-bed-part hinge 21a and is configured to rotate downward about the bed rotating shaft 10.

Further, the rear bed part 20b is connected to the other side of the bed rotating shaft 10 via the rear-bed-part hinge 21b and is configured to rotate downward about the bed rotating shaft 10.

Hereinafter, the configuration of the front-bed-part caster unit 22 and the rear-bed-part caster unit 23 formed on a lower portion of the bed unit 20 when the bed unit 20 is unfolded will be described in detail.

As shown in FIG. 2, one or more front-bed-part caster units 22 are provided on a lower portion of the front bed part 20a.

The front-bed-part caster unit 22 includes a front bed part caster 22a and a front bed part caster hinge 22b.

The front-bed-part caster unit 22 is connected to the front bed part 20a and the front bed part caster hinge 22b, and is configured such that the front bed part caster 22a protruding vertically from the lower surface of the front bed part 20a may be folded while rotating toward the lower surface of the front bed part 20a.

Further, one or more rear-bed-part caster units 23 are provided on a lower portion of the rear bed part 20b.

The rear-bed-part caster unit 23 includes a rear bed part caster 23a and a rear bed part caster hinge 23b.

The rear-bed-part caster unit 23 is connected to the rear bed part 20b and the rear bed part caster hinge 23b, and is configured such that the rear bed part caster 23a protruding vertically from the lower surface of the rear bed part 20b may be folded while rotating toward the lower surface of the rear bed part 20b.

As shown in FIG. 1, when the bed unit 20 is unfolded horizontally, the front bed part caster 22a and the rear bed part caster 23a protrude vertically from the lower surfaces of the front bed part 20a and the rear bed part 20b, respectively, so that items may be loaded and transported.

Hereinafter, the configuration of the front-bed-part caster unit 22 and the rear-bed-part caster unit 23 formed on the lower portion of the bed unit 20 in a state where the bed unit 20 is folded about the bed rotating shaft 10 will be described in detail.

As shown in FIGS. 6 and 7, the front bed part 20a and the rear bed part 20b of the bed unit 20 are configured such that they rotate and fold about the bed rotating shaft 10 to come into contact with each other on an inner lower side.

At this time, the front-bed-part caster unit 22 and the rear-bed-part caster unit 23 are rotated and folded beneath the front bed part 20a and the rear bed part 20b, respectively, so that when the bed unit 20 is folded in half, the front bed part caster 22a and the rear bed part caster 23a are also automatically folded and concealed between the folded front bed part 20a and rear bed part 20b.

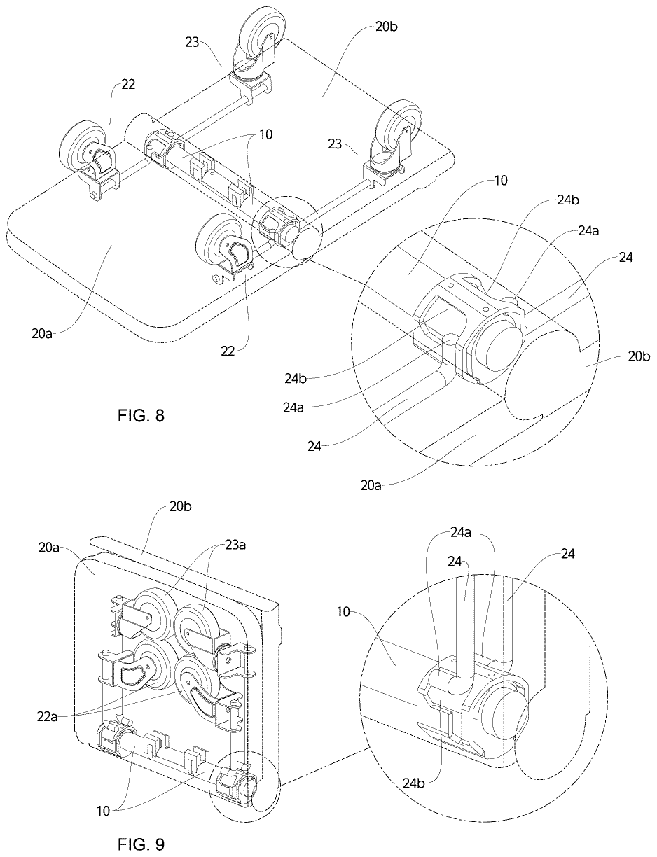

FIGS. 8 and 9 are a perspective view and a partially enlarged perspective view illustrating the configuration and operational state of a caster rod vertical protrusion 24a and a caster-rod vertical-protrusion guide groove 24b when the bed unit 20 of the flatbed trolley according to an embodiment of the present disclosure is unfolded and folded.

As shown in FIGS. 3, 8, and 9, each of the front-bed-part caster unit 22 and rear-bed-part caster unit 23 of the flatbed trolley 100 according to an embodiment of the present disclosure includes a caster rod 24 that rotates in a direction perpendicular to the rotating direction of the bed hinge unit 21.

Each caster rod 24 is connected to the bed rotating shaft 10. When each of the front bed part 20a and the rear bed part 20b rotates downward about the bed rotating shaft 10 to be folded, each of the bed casters 22a and 22b rotates to the lower surface of each of the front bed part 20a and the rear bed part 20b to be folded as each caster rod 24 rotates. When each of the front bed part 20a and the rear bed part 20b rotates in an opposite direction about the bed rotating shaft 10 to be unfolded, each of the bed casters 22a and 22b rotates in a direction perpendicular to each of the front bed part 20a and the rear bed part 20b to be unfolded as each caster rod 24 rotates in an opposite direction.

The caster rod 24 includes the caster rod vertical protrusion 24a that protrudes perpendicularly from one side thereof and rotates the caster rod 24 as the bed hinge 21a or 21b of each of the front bed part 20a and the rear bed part 20b rotates.

Further, each caster rod vertical protrusion 24a is connected to the bed rotating shaft 10. Here, the caster-rod vertical-protrusion guide groove 24b is provided at a position where the bed rotating shaft 10 meets the caster rod vertical protrusion 24a to guide the rotation of the caster rod vertical protrusion 24a that is inserted to rotate each caster rod 24 as each bed hinge 21a or 21b rotates.

As the front bed part 20a and the rear bed part 20b rotate about the bed rotating shaft 10, the caster rod vertical protrusion 24a inserted into the caster-rod vertical-protrusion guide groove 24b is guided along the shape of the caster-rod vertical-protrusion guide groove 24b and then rotated. Thus, the caster rod 24 rotates to rotate the bed casters 22a and 22b so that they are folded to the lower surfaces of the beds 20a and 20b. Thereby, when the bed unit 20 is folded in half, the front bed part caster 22a and the rear bed part caster 22b are also automatically folded and concealed between the two folded beds 20a and 20b.

In contrast, when the front bed part 20a and the rear bed part 20b are rotated about the bed rotating shaft 10 to be unfolded, the caster rod vertical protrusion 24a is guided by the caster-rod vertical-protrusion guide groove 24b to rotate the caster rod 24 in an opposite direction, so that the front bed part caster 22a and the rear bed part caster 22b are again raised and protrude vertically from the lower surface of the bed unit 20.

A flatbed trolley 100 according to another embodiment of the present disclosure may be configured such that one side of each caster rod 24 and the bed rotating shaft 10 are connected to engage with each other via bevel gears. Thus, as the front bed part 20a and the rear bed part 20b rotate about the bed rotating shaft 10, the caster rod 24 may also be rotated (not shown in the drawings).

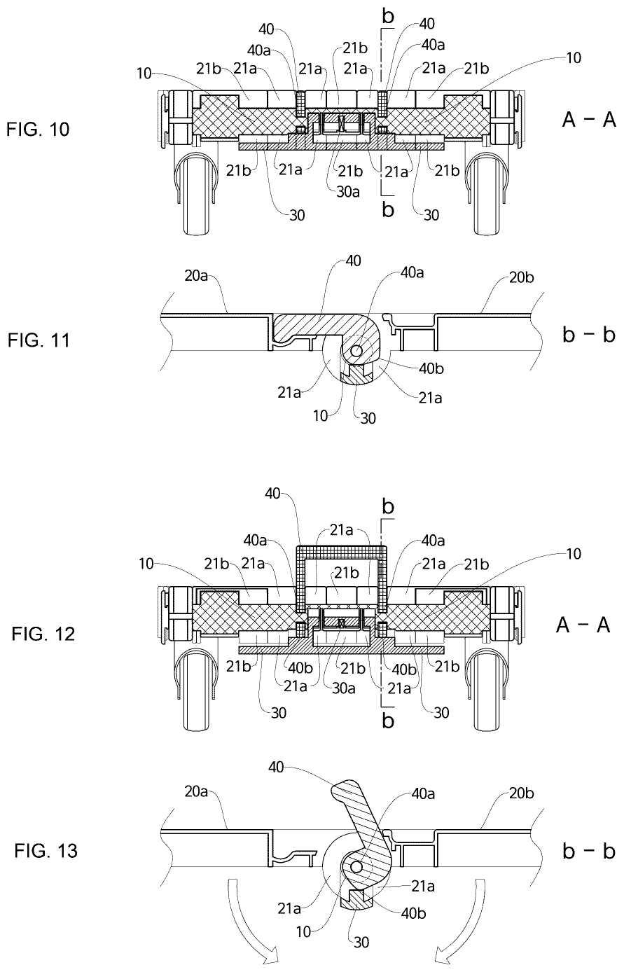

FIG. 10 is a sectional view taken along line A-A of FIG. 5 and is a conceptual sectional view explaining a structure in which a bed hinge locking bar 30 locks the bed hinge unit 21 to prevent it from rotating while a rotary lifting handle 40 of the flatbed trolley according to an embodiment of the present disclosure is lying flat.

FIG. 11 is a sectional view taken along line b-b of FIG. 10 and is a conceptual sectional view for more clearly illustrating the configuration of the rotary lifting handle 40 and the bed hinge locking bar 30 shown in FIG. 10.

FIG. 12 is a sectional view taken along line A-A of FIG. 5 in a state where the rotary lifting handle 40 of the flatbed trolley according to an embodiment of the present disclosure is lifted and is a conceptual sectional view explaining a situation in which the bed hinge locking bar 30 is released to allow the bed hinge unit 21 to rotate.

FIG. 13 is a sectional view taken along line b-b of FIG. 12 and is a conceptual sectional view for more clearly illustrating the configuration of the rotary lifting handle 40 and the bed hinge locking bar 30 shown in FIG. 12.

As shown in FIGS. 10 and 11, the flatbed trolley 100 according to an embodiment of the present disclosure may include the bed hinge locking bar 30.

The bed hinge locking bar 30 may lock the bed rotating shaft 10 and the bed hinge unit 21 connected thereto to prevent the bed unit 20 from being folded when the bed unit 20 is unfolded and used, and may unlock the bed rotating shaft and the bed hinge unit only when necessary to allow the bed unit 20 to be folded.

As shown in FIGS. 10 and 11, when the bed unit 20 is unfolded, the bed hinge locking bar 30 is inserted into the bed hinge unit 21 and locks the bed hinge unit 21 to prevent it from rotating, thereby preventing the bed unit 20 from being unintentionally folded.

Meanwhile, as shown in FIGS. 12 and 13, when one desires to fold the bed unit 20, the bed hinge locking bar 30 is removed from the bed hinge unit 21, allowing the bed hinge unit 21 to rotate, thereby enabling the bed unit 20 to be folded.

As shown in FIGS. 4 to 7 and FIGS. 10 to 13, the flatbed trolley 100 according to an embodiment of the present disclosure may include the rotary lifting handle 40.

The rotary lifting handle 40 is located in a predetermined portion where the bed rotating shaft 10 and the bed hinge unit 21 meet each other, and enables the flatbed trolley 100 to be lifted via the rotary lifting handle 40 when the bed unit 20 is folded.

As shown in FIGS. 10 to 13, one side of the rotary lifting handle 40 is connected to one side of the bed rotating shaft 10 or the bed hinge unit 21 via a rotary lifting handle hinge 40a.

The rotary lifting handle 40 includes on the other side thereof a bed hinge locking bar release protrusion 40b.

As shown in FIGS. 10 and 11, when the bed unit is unfolded, the bed hinge locking bar 30 is inserted into the bed hinge unit 21, thereby locking the bed hinge unit 21 and preventing it from rotating, so that the bed is fixed to prevent it from being unintentionally folded. At this time, the rotary lifting handle 40 is embedded in the upper surface of the bed and lies flat.

In this state, as shown in FIGS. 12 and 13, when the rotary lifting handle 40 is lifted to fold the bed unit, the bed hinge locking bar release protrusion 40b rotates about the rotary lifting handle hinge 40a, so that the bed hinge locking bar release protrusion 40b presses one end of the bed hinge locking bar 30. As a result, the bed hinge locking bar 30 is removed from the bed hinge unit, unlocking the bed hinge unit 21 and allowing it to rotate. Thus, the front bed part 20a and the rear bed part 20b may rotate and fold about the bed rotating shaft 10.

Thus, as shown in FIG. 7, when the rotary lifting handle 40 is lifted, the front bed part 20a and the rear bed part 20b, which are rotated about the bed rotating shaft 10, automatically rotate downward due to their own weights and come into contact with each other to be folded.

At this time, as shown by the dotted lines in FIG. 7, even after the front bed part 20a and the rear bed part 20b are folded, the rotary lifting handle 40 may be embedded in a space included in the bed.

The flatbed trolley 100 according to an embodiment of the present disclosure may include a bed hinge locking bar spring 30a.

As shown in FIGS. 10 and 12, the bed hinge locking bar spring 30a may be provided between the bed rotating shaft 10 and the bed hinge locking bar 30 so that the bed hinge locking bar 30 is automatically inserted into the bed hinge unit 21 when the bed unit 20 is unfolded.

That is, when the bed unit 20 is unfolded by the elasticity of the bed hinge locking bar spring 30a, the bed hinge unit 21 may be automatically locked without a separate operation.

The flatbed trolley 100 according to another embodiment of the present disclosure may include a fixed lifting handle hole 41, a fixed lifting handle 41a, and a bed hinge release button 41b, instead of the rotary lifting handle 40.

Hereinafter, as another embodiment of the present disclosure, a method in which the bed hinge unit 21 is locked or released by the configuration of the fixed lifting handle 41a through the fixed lifting handle hole 41 and the bed hinge release button 41b will be described.

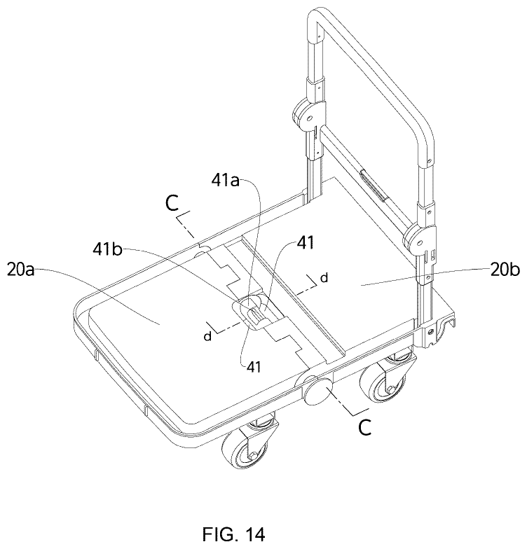

FIG. 14 is a perspective view illustrating the flatbed trolley to which the fixed lifting handle 41a is applied, according to another embodiment of the present disclosure.

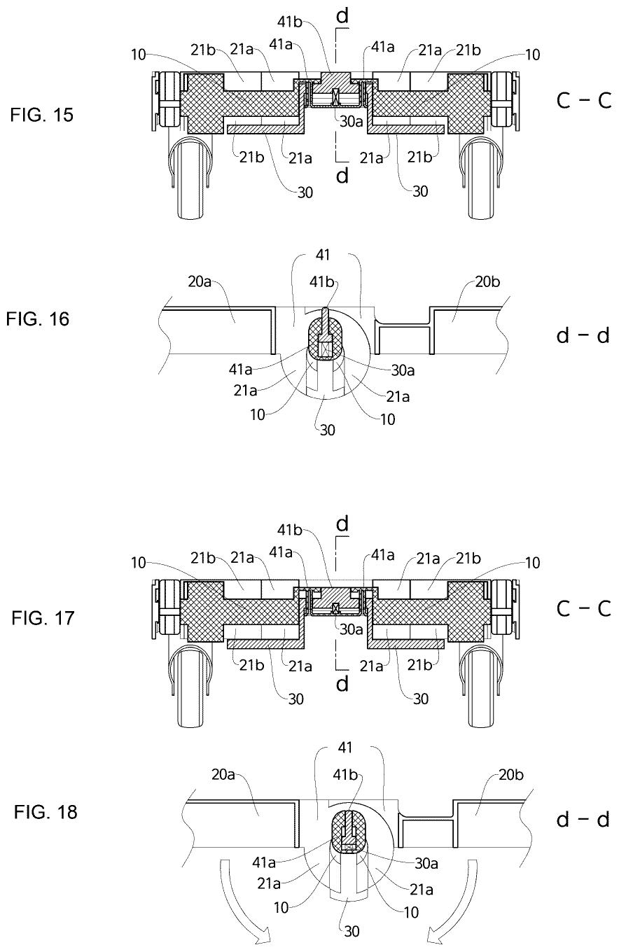

FIG. 15 is a sectional view taken along line C-C of FIG. 14 and is a conceptual sectional view explaining a situation in which the bed hinge locking bar 30 locks the bed hinge unit 21 to prevent it from rotating while the bed hinge release button 41b of the flatbed trolley according to another embodiment of the present disclosure is not pressed.

FIG. 16 is a sectional view taken along line d-d of FIG. 15 and is a conceptual sectional view for more clearly illustrating the state of the bed hinge release button 41b of the fixed lifting handle 41a and the bed hinge locking bar 30 shown in FIG. 15.

FIG. 17 is a sectional view taken along line C-C of FIG. 14 in a state where the bed hinge release button 41b of the flatbed trolley according to another embodiment of the present disclosure is pressed and is a conceptual sectional view explaining a situation in which the bed hinge locking bar 30 is released so that the bed hinge unit 21 can rotate.

FIG. 18 is a sectional view taken along line d-d of FIG. 17 and is a conceptual sectional view for more clearly illustrating the state of the bed hinge release button 41b and the bed hinge locking bar 30 shown in FIG. 17.

According to another embodiment of the present disclosure, the flatbed trolley 100 may include, as shown in FIGS. 14 to 18, a fixed lifting handle hole 41 in a predetermined portion where the bed rotating shaft 10 and the bed hinge unit 21 meet each other, so as to hold and lift the bed rotating shaft 10 of the flatbed trolley 100 by hand.

A portion of the bed rotating shaft 10 exposed through the fixed lifting handle hole 41 may be configured to serve as the fixed lifting handle 41a.

At this time, the fixed lifting handle 41a may be provided with the bed hinge release button 41b to release the bed hinge locking bar 30.

As shown in FIGS. 15 and 16, when the bed unit is unfolded, the bed hinge locking bar 30 is inserted into the bed hinge unit 21, thereby locking the bed hinge unit 21 to prevent it from rotating, so that the bed is secured against unintentional folding. At this time, the bed hinge release button 41b protrudes to the upper surface of the fixed lifting handle 41a.

In this state, when folding the bed unit 20, as shown in FIGS. 17 and 18, pressing the bed hinge release button 41 b causes the bed hinge locking bar 30 connected thereto to be disengaged from the bed hinge unit 21, thereby unlocking the bed hinge unit 21 and allowing it to rotate. As a result, the front bed part 20a and the rear bed part 20b may rotate about the bed rotating shaft 10 to be folded.

In this case, when the fixed lifting handle 41a is lifted while the bed hinge release button 41b is being pressed, the bed hinge locking bar 30 is released, allowing the flatbed trolley 100 to be lifted. Thus, the front bed part 20a and the rear bed part 20b automatically rotated downward about the bed rotating shaft 10 due to their own weights and come into contact with each other to be folded.

Even in this case, as shown in FIGS. 15 and 18, the bed hinge locking bar spring 30a may be provided between the bed rotating shaft 10 and the bed hinge locking bar 30 so that the bed hinge locking bar 30 is automatically inserted into the bed hinge unit 21 when the bed unit 20 is unfolded.

That is, when the bed unit 20 is unfolded by the elasticity of the bed hinge locking bar spring 30a, the bed hinge unit 21 may be automatically locked without a separate operation.

As shown in FIGS. 1 to 7, the flatbed trolley 100 according to an embodiment of the present disclosure may include, on one side of the bed unit 20, the trolley handle unit 50 for pushing or pulling the flatbed trolley 100.

Meanwhile, the flatbed trolley 100 may also be configured without the trolley handle unit 50 (not shown in the drawings).

Hereinafter, the configuration of the trolley handle unit 50 in the flatbed trolley 100 including the trolley handle unit 50 will be described in detail with reference to FIGS. 1 to 7 and FIGS. 19 to 21.

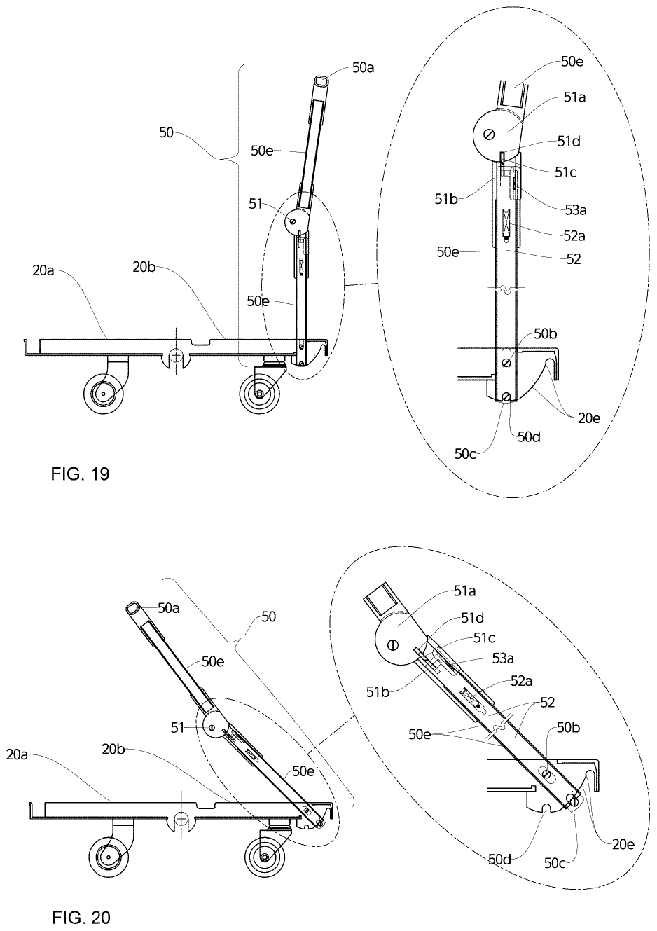

FIG. 19 is a sectional view and a partially enlarged sectional view showing a state in which the trolley handle unit 50 of the flatbed trolley according to an embodiment of the present disclosure is supported when erected.

FIG. 20 is a sectional view and a partially enlarged sectional view showing an intermediate process in which the trolley handle unit 50 of the flatbed trolley according to an embodiment of the present disclosure is folded onto the upper surface of the bed unit 20.

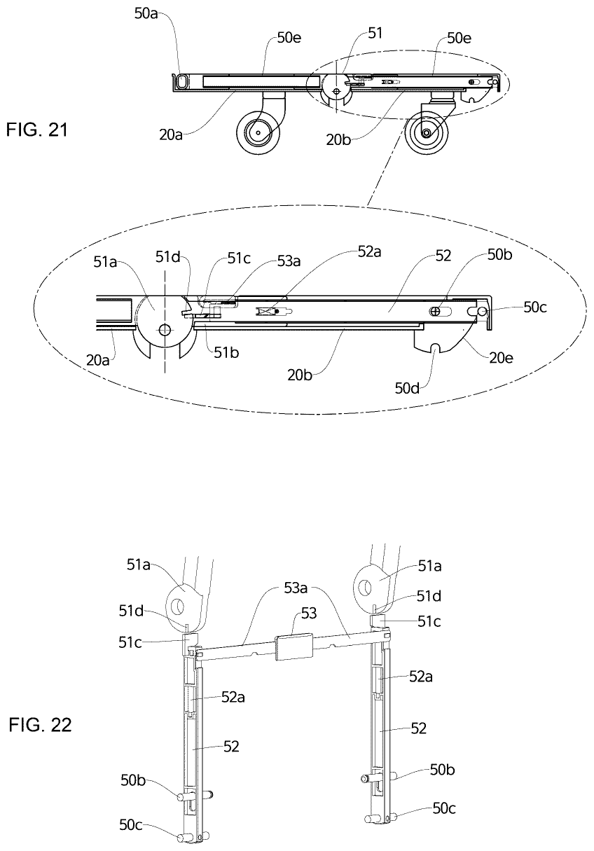

FIG. 21 is a sectional view and a partially enlarged sectional view showing a state in which the trolley handle unit 50 of the flatbed trolley according to an embodiment of the present disclosure is folded and embedded in a trolley-handle storage groove 20c on the upper surface of the bed unit 20 and then is foldable together with the bed unit.

As shown in FIGS. 19 to 21, the trolley handle unit 50 may be composed of a trolley handle 50a which is directly held by hand to push or pull the trolley, and a trolley-handle support bar 50e which connects the trolley handle 50a to one side of the bed unit 20 and supports it.

The trolley-handle support bar 50e may be connected to the bed unit 20 via a trolley-handle lower hinge 50b, allowing the trolley handle unit 50 to be folded down toward the upper surface of the bed unit 20.

At this time, a trolley-handle fixing projection 50c is provided on the lower end of the trolley-handle support bar 50e, and a trolley-handle fixing-projection insertion groove 50d is provided on one end of the bed unit 20 that meets the fixing projection. Thus, when the trolley handle unit 50 is in an upright position, the trolley-handle fixing projection 50c is inserted into the trolley-handle fixing-projection insertion groove 50d, thereby supporting the trolley handle unit 50 to prevent it from being unintentionally folded.

When the trolley-handle fixing projection 50c is released from the trolley-handle fixing-projection insertion groove 50d, the trolley handle 50 may be folded down toward the upper surface of the bed unit 20.

Further, at this time, as shown in FIGS. 19 to 21, the trolley handle unit 50 is provided with a trolley-handle bending hinge 51 so that when the bed unit 20 rotates about the bed rotating shaft 10 to be folded, it can be folded together with the trolley-handle support bar 50e.

The trolley-handle bending hinge 51 is composed of an upper trolley-handle bending hinge 51a and a lower trolley-handle bending hinge 51b, which are connected to each other by a hinge, allowing them to rotate relative to each other and fold.

Either the upper trolley-handle bending hinge 51a or the lower trolley-handle bending hinge 51b is provided with a trolley-handle bending hinge fixing plate 51c, and the other, i.e., the corresponding upper trolley-handle bending hinge 51a or lower trolley-handle bending hinge 51b is provided with a trolley-handle bending hinge fixing-plate insertion groove 51d. Thus, as shown in FIG. 19, when the trolley-handle bending hinge fixing plate 51c is inserted into the trolley-handle bending hinge fixing-plate insertion groove 51d, the trolley handle unit 50 is supported in an unfolded state without being folded around the trolley-handle bending hinge 51.

That is, as shown in FIG. 19, when the trolley handle unit 50 is in the upright position, the trolley-handle fixing projection 50c is fixedly inserted into the trolley-handle fixing-projection insertion groove 50d, and simultaneously, the trolley-handle bending hinge fixing plate 51c is fixedly inserted into the trolley-handle bending hinge fixing-plate insertion groove 51d. As a result, both the trolley-handle lower hinge 50b and the trolley-handle bending hinge 51 are fixed, allowing the trolley handle unit 50 to be fully supported.

In contrast, as shown in FIG. 21, when the trolley handle unit 50 is laid down on the upper surface of the bed unit 20, the trolley-handle bending hinge fixing plate 51c is released from the trolley-handle bending hinge fixing-plate insertion groove 51d. At this time, the trolley handle unit 50 is in a state where it can rotate and fold around the trolley-handle bending hinge 51. Thus, when the bed unit 20 is folded by rotating about the bed rotating shaft 10, the trolley handle unit 50 is also folded by rotating about the trolley-handle bending hinge 51.

At this time, as shown in FIGS. 1 to 5, the flatbed trolley 100 according to an embodiment of the present disclosure may be further provided with a trolley-handle intermediate connecting bar 50f that connects both the trolley-handle support bars 50e to the trolley handle unit 50.

In addition, the bed unit 20 may include a trolley-handle storage groove 20c and a trolley-handle intermediate connecting bar storage groove 20d so that the trolley handle unit 50 may be embedded and stored therein when folded to the upper surface of the bed unit 20.

Thus, in the flatbed trolley 100 according to an embodiment of the present disclosure, when the trolley handle unit 50 is folded to the upper surface of the bed unit 20, the trolley handle unit 50 is completely embedded in the trolley-handle storage groove 20c of the bed unit 20. In this state, the trolley takes on a handle-less transport trolley, making it more suitable for loading and transporting larger items on the upper surface of the bed unit 20.

Further, when the flatbed trolley 100 is completely folded as shown in FIG. 7, the trolley handle unit 50 is folded to be completely embedded in the bed unit 20, thereby reducing the folded thickness of the flatbed trolley 100.

FIG. 22 is a perspective view showing a configuration in which the trolley-handle fixing part connecting rod 52 and the trolley-handle release button connecting rod 53a are connected to each other so that the trolley-handle fixing projection 50c, the trolley-handle bending hinge fixing plate 51c, and the trolley-handle release button 53 can all move integrally.

As shown in FIGS. 3 and 22, in the flatbed trolley 100 according to an embodiment of the present disclosure, the trolley handle unit 50 is provided with a trolley-handle fixing part connecting rod 52 that connects the trolley-handle fixing projection 50c and the trolley-handle bending hinge fixing plate 51c so that they move integrally.

Further, the trolley-handle release button 53 is provided to perform a release operation by pressing or pulling the trolley-handle fixing projection 50c and the trolley-handle bending hinge fixing plate 51c connected to each other, and the trolley-handle release button connecting rod 53a is provided to connect the trolley-handle release button 53 with the trolley-handle fixing projection 50c and the trolley-handle bending hinge fixing plate 51c, which are interconnected to each other. Thus, by pressing or pulling the trolley-handle release button 53, the trolley-handle fixing projection 50c and the trolley-handle bending hinge fixing plate 51c, which are connected to each other, can be released simultaneously.

At this time, as shown in FIGS. 19 to 22, one end of the trolley-handle fixing part connecting rod 52 is provided with a trolley-handle fixing part connecting rod spring 52a, which is configured to push the connected trolley-handle fixing projection 50c and trolley-handle bending hinge fixing plate 51c in a direction that maintains the locked state.

With this configuration, by performing a single operation—either pushing or pulling the trolley-handle release button 53—the trolley-handle fixing projection 50c and the trolley-handle bending hinge fixing plate 51c, which are connected via the trolley-handle release button connecting rod 53a and the trolley-handle fixing part connecting rod 52, are simultaneously released, thereby allowing the trolley handle unit 50 to be folded.

In contrast, when the trolley handle unit 50 is in the upright position, the trolley-handle fixing projection 50c is automatically inserted into the trolley-handle fixing-projection insertion groove 50d by the trolley-handle fixing part connecting rod spring 52a, thereby fixing the trolley handle unit 50. At the same time, the trolley-handle bending hinge fixing plate 51c is also automatically inserted into the trolley-handle bending hinge fixing-plate insertion groove 51d, allowing the trolley-handle bending hinge 51 to be supported without folding.

If necessary, the trolley-handle fixing part connecting rod 52 and the trolley handle release button connecting rod 53a may be embedded in components, such as the trolley-handle support bar 50e and the trolley-handle intermediate connecting bar 50f, to be operated.

As shown in FIGS. 1 to 5 and FIGS. 19 to 21, the flatbed trolley 100 according to an embodiment of the present disclosure is provided with a trolley-handle fixing projection guide 20e on one side of the bed unit 20 that meets the trolley-handle fixing projection 50c. When the trolley handle unit 50 is laid down toward the upper surface of the bed unit 20, the trolley-handle fixing projection guide 20e pulls the trolley-handle fixing projection 50c. At this time, the trolley-handle bending hinge fixing plate 51c connected to the trolley-handle fixing part connecting rod 52 is also automatically pulled to be released. Thus, when the bed unit 20 is unfolded and the trolley handle unit 50 is laid down toward the upper surface of the bed unit 20, the trolley handle unit 50 may be folded in half or unfolded, and the laid-down trolley handle unit 50 may be raised without requiring any additional unlocking operation, such as pressing or pulling the trolley-handle release button 53.

Hereinafter, a process in which the flatbed trolley 100 of the present disclosure is unfolded to be used or folded through the organic interrelationship of components of the present disclosure will be described.

With the above-described configuration, the flatbed trolley 100 according to the present disclosure, when the two beds are unfolded in the horizontal direction, as shown in FIG. 1, enters a state in which the front bed part caster 22a and the rear bed part caster 23a protrude vertically from the lower surface of each bed, allowing items to be loaded and transported. In this state, the bed hinge locking bar 30 is automatically inserted into the bed hinge unit 21 by the bed hinge locking bar spring 30a, thereby securing the bed unit 20 to prevent it from folding unintentionally. This allows the flatbed trolley 100 to be stably used.

In this state, when the trolley handle unit 50 is in the upright position, the trolley-handle fixing projection 50c is inserted into the trolley-handle fixing-projection insertion groove 50d. At the same time, the trolley-handle bending hinge fixing plate 51c is inserted into the trolley-handle bending hinge fixing-plate insertion groove 51d, so that the trolley handle unit 50 is fully supported, making it easy to push or pull the flatbed trolley.

Further, when the trolley handle unit 50 is laid down toward the upper surface of the bed unit 20 while the trolley-handle release button 53 is being pressed, the trolley handle unit 50 is fully embedded in the trolley-handle storage groove 20c and the trolley-handle intermediate connecting bar storage groove 20d, transforming the trolley into a handle-less trolley. This allows the trolley to be effectively used for loading and transporting bulky items.

In this state, the trolley-handle bending hinge 51 is released by the trolley-handle fixing projection guide 20e, so that the trolley handle unit 50 may be folded when the bed unit 20 is folded.

Therefore, in this state, in order to fully fold the flatbed trolley 100, lifting the rotary lifting handle 40 causes the bed hinge locking bar release protrusion 40b to automatically release the bed hinge locking bar 30, thereby allowing the bed hinge unit 21 to rotate about the bed rotating shaft 10 and fold. Along with this, the trolley handle unit 50 embedded in the bed unit 20 is also folded while rotating about the trolley-handle bending hinge 51. At this time, the caster rod vertical protrusions 24a inserted into the bed rotating shaft 10 also rotate along the caster-rod vertical-protrusion guide groove 24b. Thus, the front bed part caster 22a and the rear bed part caster 22b, which are connected to the caster rod 24, rotate as well and are folded and concealed between the front bed part 20a and the rear bed part 20b.

In contrast, when the flatbed trolley 100 is unfolded, simply unfolding the bed unit 20 causes the bed hinge unit 21 to rotate in a reverse direction about the bed rotating shaft 10. Thus, the caster rod vertical protrusions 24ainserted into the bed rotating shaft 10 rotate in the reverse direction along the caster-rod vertical-protrusion guide groove 24b, thereby causing the front bed part caster 22a and the rear bed part caster 23a, which are connected to the caster rod 24, to rotate in the reverse direction and stand upright to protrude vertically from the lower surface of the bed unit 20. At this time, the trolley handle unit 50 also rotates together with the bed unit 20 and is unfolded while being embedded in the upper surface of the bed unit.

Then, in this state, when the trolley handle unit 50 is lifted, the trolley-handle fixing part connecting rod 52 is pushed upward by the elasticity of the trolley-handle fixing part connecting rod spring 52a. Thus, the trolley-handle fixing projection 50c is inserted into the trolley-handle fixing-projection insertion groove 50d, and simultaneously, the trolley-handle bending hinge fixing plate 51c is inserted into the trolley-handle bending hinge fixing-plate insertion groove 51d, thereby supporting the trolley handle unit 50 in a state where it is not folded.

With this configuration, the flatbed trolley 100 according to the present disclosure can be folded and unfolded very conveniently through a single operation.

As described above, the present disclosure has been described in detail with reference to embodiments. However, these embodiments are merely illustrative, and the present disclosure should not be understood as being limited to these embodiments. The scope of the present disclosure should be interpreted based on the appended claims and their equivalents.

### DESCRIPTION OF MAIN COMPONENTS

100: flatbed trolley
10: bed rotating shaft
20: bed unit
20a: front bed part
20b: rear bed part
20c: trolley-handle storage groove
20d: trolley-handle intermediate connecting bar storage groove
20e: trolley-handle fixing projection guide
21: bed hinge unit
21a: front-bed-part hinge
21b: rear-bed-part hinge
22: front-bed-part caster unit
22a: front bed part caster
22b: front bed part caster hinge
23: rear-bed-part caster unit
23a: rear bed part caster
23b: rear bed part caster hinge
24: caster rod
24a: caster rod vertical protrusion
24b: caster-rod vertical-protrusion guide groove
30: bed hinge locking bar
30a: bed hinge locking bar spring
40: rotary lifting handle
40a: rotary lifting handle hinge
40b: bed hinge locking bar release protrusion
41: fixed lifting handle hole
41a: fixed lifting handle
41b: bed hinge release button
50: trolley handle unit
50a: trolley handle
50b: trolley-handle lower hinge
50c: trolley-handle fixing projection
50d: trolley-handle fixing-projection insertion groove
50e: trolley-handle support bar
50f: trolley-handle intermediate connecting bar
51: trolley-handle bending hinge
51a: upper trolley-handle bending hinge
51b: lower trolley-handle bending hinge
51c: trolley-handle bending hinge fixing plate
51d: trolley-handle bending hinge fixing-plate insertion groove
52: trolley-handle fixing part connecting rod
52a: trolley-handle fixing part connecting rod spring
53: trolley-handle release button
53a: trolley-handle release button connecting rod.

1. A flatbed trolley comprising:
a bed rotating shaft; and
a bed unit placed parallel to the ground so that an item is loaded thereon;
wherein the bed unit is connected to the bed rotating shaft via a bed hinge unit;
wherein the bed unit comprises a front bed part and a rear bed part;
wherein the bed hinge unit comprises a front-bed-part hinge and a rear-bed-part hinge;
wherein the front bed part is connected to one side of the bed rotating shaft via the front-bed-part hinge and is configured to rotate downward about the bed rotating shaft;
wherein the rear bed part is connected to the other side of the bed rotating shaft via the rear-bed-part hinge and is configured to rotate downward about the bed rotating shaft;
wherein the front bed part comprises on a lower portion thereof one or more front-bed-part caster units;
wherein the front-bed-part caster unit comprises a front bed part caster and a front bed part caster hinge;
wherein the front-bed-part caster unit is connected to the front bed part and the front bed part caster hinge, and is configured such that the front bed part caster protruding vertically from a lower surface of the front bed part is foldable while rotating toward the lower surface of the front bed part;
wherein the rear bed part comprises on a lower portion thereof one or more rear-bed-part caster units;
wherein the rear-bed-part caster unit comprises a rear bed part caster and a rear bed part caster hinge;
wherein the rear-bed-part caster unit is connected to the rear bed part and the rear bed part caster hinge, and is configured such that the rear bed part caster protruding vertically from a lower surface of the rear bed part is foldable while rotating toward the lower surface of the rear bed part;
wherein when the bed unit is unfolded horizontally, the front bed part caster and the rear bed part caster protrude vertically from the lower surfaces of the front bed part and the rear bed part, respectively;
wherein, when the front bed part and the rear bed part of the bed unit are rotated and folded about the bed rotating shaft so that they come into contact with each other on an inner lower side, the front-bed-part caster unit and the rear-bed-part caster unit are rotated and folded beneath the front bed part and the rear bed part, respectively, so that the bed unit is folded in half and simultaneously the front bed part caster and the rear bed part caster are also automatically folded and concealed between the folded front bed part and rear bed part; and
wherein the bed hinge unit connected to the bed rotating shaft comprises a bed hinge locking bar that locks the bed hinge unit to prevent the bed unit from being folded when the bed unit is unfolded and used, and unlocks the bed hinge unit only when necessary to allow the bed unit to be folded.

2. The flatbed trolley of claim 1, wherein:
each of the front-bed-part caster unit and rear-bed-part caster unit comprises a caster rod that rotates in a direction perpendicular to a rotating direction of the bed hinge unit;
each caster rod is connected to the bed rotating shaft;
when each of the front bed part and the rear bed part rotates downward about the bed rotating shaft to be folded, each of the bed casters rotates to the lower surface of each of the front bed part and the rear bed part to be folded as each caster rod rotates;
when each of the front bed part and the rear bed part rotates in an opposite direction about the bed rotating shaft to be unfolded, each of the bed casters rotates in a direction perpendicular to each of the front bed part and the rear bed part to be unfolded as each caster rod rotates in an opposite direction.

3. The flatbed trolley of claim 2, wherein:
the caster rod comprises a caster rod vertical protrusion that protrudes perpendicularly from one side thereof and rotates the caster rod as the bed hinge of each of the front bed part and the rear bed part rotates;
the bed rotating shaft comprises a caster-rod vertical-protrusion guide groove at a position where it meets the caster rod vertical protrusion to guide rotation of the caster rod vertical protrusion that is inserted to rotate the caster rod as each bed hinge rotates; and
as the front bed part and the rear bed part rotate about the bed rotating shaft, the caster rod vertical protrusion is rotated along a shape of the caster-rod vertical-protrusion guide groove, thereby rotating the caster rod.

4. The flatbed trolley of claim 2, wherein:
one side of each caster rod and the bed rotating shaft are connected to engage with each other via bevel gears; and
as the front bed part and the rear bed part rotate about the bed rotating shaft by rotation of the bevel gears, the caster rod is rotated.

5. The flatbed trolley of claim 1, wherein:
a rotary lifting handle is provided on a predetermined portion where the bed rotating shaft and the bed hinge unit meet each other, so as to lift the flatbed trolley when the bed unit is folded;
one side of the rotary lifting handle is connected to one end of the bed rotating shaft or the bed hinge unit via a rotary lifting handle hinge;
the rotary lifting handle comprises on the other side thereof a bed hinge locking bar release protrusion; and
as the bed hinge locking bar release protrusion rotates about the rotary lifting handle hinge when the rotary lifting handle is lifted, the bed hinge locking bar release protrusion presses one end of the bed hinge locking bar, so that the bed hinge locking bar is removed from the bed hinge unit, thereby unlocking the bed hinge unit and allowing it to rotate, whereby the front bed part and the rear bed part automatically rotate and fold about the bed rotating shaft.

6. The flatbed trolley of claim 1, wherein:
a fixed lifting handle hole is provided in a predetermined portion where the bed rotating shaft and the bed hinge unit meet each other, so as to hold and lift the bed rotating shaft of the flatbed trolley by hand;
a portion of the bed rotating shaft exposed through the fixed lifting handle hole is configured to serve as the fixed lifting handle;
the fixed lifting handle is provided with a bed hinge release button to release the bed hinge locking bar;
when the bed unit is folded, pressing the bed hinge release button causes the bed hinge locking bar connected thereto to be disengaged from the bed hinge unit, thereby unlocking the bed hinge unit and allowing it to rotate;
whereby the front bed part and the rear bed part rotate about the bed rotating shaft to be folded.

7. The flatbed trolley of claim 1, wherein a trolley handle unit for pushing or pulling the flatbed trolley is provided on one side of the bed unit.

8. The flatbed trolley of claim 7, wherein:
the trolley handle unit comprises a trolley handle that is directly held by hand to push or pull the trolley, and a trolley-handle support bar that connects the trolley handle to one side of the bed unit and supports it;
the trolley-handle support bar is connected to the bed unit via the trolley-handle lower hinge, allowing the trolley handle unit to be folded down toward an upper surface of the bed unit;
a trolley-handle fixing projection is provided on a lower end of the trolley-handle support bar;
a trolley-handle fixing-projection insertion groove is provided on one end of the bed unit that meets the fixing projection, so that when the trolley handle unit is in an upright position, the trolley-handle fixing projection is inserted into the trolley-handle fixing-projection insertion groove, thereby supporting the trolley handle unit to prevent it from being unintentionally folded;
the trolley handle unit is provided with a trolley-handle bending hinge to be folded together with the trolley-handle support bar, when the bed unit rotates about the bed rotating shaft to be folded;
the trolley-handle bending hinge is composed of an upper trolley-handle bending hinge and a lower trolley-handle bending hinge, which are connected to each other by a hinge, allowing them to rotate relative to each other and fold;
the upper trolley-handle bending hinge or the lower trolley-handle bending hinge comprises on one side thereof a trolley-handle bending hinge fixing plate;
the upper trolley-handle bending hinge or the lower trolley-handle bending hinge comprises on the other side thereof a trolley-handle bending hinge fixing-plate insertion groove, so that when the trolley-handle bending hinge fixing plate is inserted into the trolley-handle bending hinge fixing-plate insertion groove, the trolley handle unit is supported in an unfolded state without being folded around the trolley-handle bending hinge; and
when the trolley-handle bending hinge fixing plate is disengaged and released from the trolley-handle bending hinge fixing-plate insertion groove, the trolley handle unit becomes in a state where it is rotatable and foldable around the trolley-handle bending hinge, so that when the bed unit is folded by rotating about the bed rotating shaft, the trolley handle unit is also folded by rotating about the trolley-handle bending hinge.

9. The flatbed trolley of claim 8, wherein:
the trolley handle unit comprises a trolley-handle fixing part connecting rod that connects the trolley-handle fixing projection and the trolley-handle bending hinge fixing plate to each other so that the trolley-handle fixing projection and the trolley-handle bending hinge fixing plate are integrally moved;
a trolley-handle release button is provided to perform a release operation by pressing or pulling the trolley-handle fixing projection and the trolley-handle bending hinge fixing plate connected to each other;
a trolley-handle release button connecting rod is provided to connect the trolley-handle release button with the trolley-handle fixing projection and the trolley-handle bending hinge fixing plate, which are interconnected to each other; and
through a single operation of pressing or pulling the trolley-handle release button, the trolley-handle fixing projection and the trolley-handle bending hinge fixing plate, which are connected to each other, are released simultaneously.

10. The flatbed trolley of claim 9, wherein:
a trolley-handle fixing projection guide is provided on one side of the bed unit that meets the trolley-handle fixing projection;
when the trolley handle unit is laid down toward the upper surface of the bed unit, the trolley-handle fixing projection guide pulls the trolley-handle fixing projection;
the trolley-handle bending hinge fixing plate connected to the trolley-handle fixing part connecting rod is also automatically pulled to be released, so that when the bed unit is unfolded and the trolley handle unit is laid down toward the upper surface of the bed unit, the trolley handle unit is folded in half or unfolded, and the laid-down trolley handle unit is raised without requiring any additional unlocking operation, such as pressing or pulling the trolley-handle release button.
